(19) United States
(12) Patent Application Publication
(10) Pub. No.: US 2018/0268072 A1
(43) Pub. Date: Sep. 20, 2018

(54) Method and system for selecting from searched users of network and send connection request to selected users and establishing connection based on acceptance of connection request by said selected users

(71) Applicant: Yogesh Rathod, Mumbai (IN)

(72) Inventor: Yogesh Rathod, Mumbai (IN)

(21) Appl. No.: 15/997,714

(22) Filed: Jun. 5, 2018

Related U.S. Application Data
(63) Continuation of application No. PCT/IB2018/053889, filed on May 31, 2018.

(51) Int. Cl. G06F 17/30; G06Q 20/08

(52) U.S. Cl. CPC G06F 17/30867; G06Q 20/085; G06F 17/30554

(57) ABSTRACT

Various embodiments of a system, methods, platform, database, search engine & device for enabling user to search any users of network based on one or more keywords, criteria, selections, types, categories and settings. Server searches, matches, retrieves and generates search results and displaying said search results to said searching user and enabling to view search results, view search result item associated user's profile (In an embodiment server provides profile without disclosing identities of search results associated users) and select one or more users or search result items from said displayed search results and click or tap on “connect button to send request to connect to said each selected users of network. Server send notification to said request to connect to said each selected users of network and enable request receiving each user to view subject or short details or requirement to connect provided by requesting user and enable to accept request to connect, ignore or cancel or reject request to connect, schedule request to connect and ask requesting user to make particular amount of payment to enable requesting user to connect with request receiving user. In the event of acceptance of connection request by said selected user or invitor, establishing connection between them and enable both invitee or user and invitor to communicate, share, participate, collaborate, transact with each other.

### FIELD OF INVENTION

The present invention relates generally to enabling user to search any users of network based on one or more keywords, criteria, selections, types, categories and settings. Server searches, matches, retrieves and generates search results and displaying said search results to said searching user and enabling to view search results, view search result item associated user's profile (In an embodiment server provides profile without disclosing identities of search results associated users) and select one or more users or search result items from said displayed search results and click or tap on “connect button to send request to connect to said each selected users of network. Server send notification to said request to connect to said each selected users of network and enable request receiving each user to view subject or short details or requirement to connect provided by requesting user and enable to accept request to connect, ignore or cancel or reject request to connect, schedule request to connect and ask requesting user to make particular amount of payment to enable requesting user to connect with request receiving user. In the event of acceptance of connection request by said selected user or invitor, establishing connection between them and enable both invitee or user and invitor to communicate, share, participate, collaborate, transact with each other.

### BACKGROUND OF THE INVENTION

In professional networks, for example LinkedIn user needs to [1] create and manage profile, [2] search users of network based on search queries, [3] send invitation to connect to each selected user of network and [4] in the event of acceptance of connection request, both users are mutually connect [5] then communicate with each other. To build and manage contextual and relevant connections lot of time and money required. If no manually connection happens or user wants to directly send message to any user of network then user can use paid In-Mails of LinkedIn, but for that user needs to search profile and tap on “InMail” from each profile to send message and there is no guarantee of reply or delay in reply. It's very slow to make connections and getting responses. Other disadvantages are privacy (open profile), spam (spam connections and messages), fake profiles (multiple accounts of single user), huge costs (need to subscribe premium account for better search and connections).

Present invention covers system in which there is no need to search each connection and send invitation to connect to each selected user of network and wait for acceptance or rejection of invitation which saves enormous time and money. It's possible to instantly, in light speed contextually connect with other users of network. Such on-demand and real-time instant connectivity with required users of network, enables requesting user to instantly communicate with other users of network based on keywords, types of selections (e.g. criteria), and settings. Present invention covers system in which after registration and providing or importing profile, [1] user can prepare connection request by providing keywords, agenda or subject or brief requirement specification, select options including Name, Company, School, College, Title, Locations, Current or Past Companies, one or more fields and any combination thereof, select preferences including number of required connections, users who are online or any time or specific time, users who are within contacts, and can provide sort order (e.g. Rank). [2] Based on user request or requirements, server searches and matches users of network and displaying to user list of searched and matched users to enable searching user to view profile & rank to identify contextual users and select users from list of searched users and tap on “Connect” button. [3] Server notifies said selected users with brief subject (e.g. “Want to consult patent attorney for filing patent application in accelerated mode”), so notified user can determine whether to connect or not and [4] in the event of acceptance of request by said each selected user, requesting user can real-time connect with each request accepted user and then communicate, collaborate, share, transact and converse with them. Therefore, it is with respect to these considerations and others that the present invention has been made. Present invention does not require to creation invitation based mutual connections. There is no need to search and send invitation to selected users and wait for acceptance of invitation from them to mutually connect with them. All known and related users identified and connected by importing contacts (via emails, phone and social contacts) and by enabling to search based on (e.g. Keywords, First name, Last Name, Company etc.) and enable to select and associate one or more types of relationship e.g. Friend, Family, Employee, Employer, Partner, Co-worker or Colleague or Associate or Team member and like. In the event of providing relationship, notifying to relation associated user to enable to associate relationship back (If true). In the event of both provide relationship to each other than both are mutually connected or become in contacts. Based on said contacts, server identifies Contacts of Contacts. In an embodiment searching user can view profile details of users in contacts and contacts of contacts.

In professional networks, for example LinkedIn Sales Navigator™ enables sales person to searching, matching and identifying leads. In marketing, lead generation is the initiation of consumer interest or enquiry into products or services of a business. Lead generation is often paired with lead management to move leads through the purchase funnel. This combination of activities is referred to as pipeline marketing. A lead is usually allotted to an individual to follow up on. Once the individual (e.g. salesperson) reviews and qualifies it to have potential business, the lead gets converted to an opportunity for a business. The opportunity then has to undergo multiple sales stages before the deal is won. Present invention enables decision makers, enterprises, manufacturers, businesses and companies to publish one or more types of requirements and associated details including requirement specifications, product or service specifications, so contextual sales persons or professionals can directly connect and communicate with them and can present product or services, negotiate, workflow, convey with them and very fast close sales or deals with them. In professional networks, for example LinkedIn provides solution to job seekers to search and apply for job which recruiters notifies and after process recruiters approach job seekers and provides solution to recruiters to search, attract, and identify job seekers and communicate with them. Present invention enables more real-time and direct approach between job seekers and recruiters. Both gets chance to communicate with each other. Job seekers can connect with matched and contextual recruiters and communicates with them, ask queries, convey them, share profile and negotiates salary. Recruiters can communicate with matched and contextual job seekers and communicates with them. Real-time contextually connecting and communication enables both to solve initial queries and much faster creates interest and move forward to next steps.

### OBJECT OF THE INVENTION

The principal object of the present invention is to identifying request specific users of network and connecting requestor selected users from said identified users, wherein connection happens based on acceptance of connection request by request receiving user.

The other object of the present invention is to enable to make conversation contents ephemeral based on pre-set duration and/or receiving instruction from at least one of the connected user or conversation participated user or member. Before removing ephemeral content, server identifies each keyword of conversation contents and check whether said keyword exist in database or dictionary or index, if said keyword not exist then server stores keywords and associated metadata and if exists then server stores metadata with said already stored keyword, wherein metadata comprise unique user identity of user who send message, unique user identity of user who received message, data & time of sending of message, data & time of receiving of message, location or place where user send or receive message, device type and name, browser type and name, number of times of occurrence of said keyword in said sender or receiving user, identified conversed content associate photo or video (series of image(s)) or voice or image or file associated identified keywords based on object recognition or face or body part recognition or voice recognition or optical character recognition in photo or video, store message associated one or more types of reaction including like, dislike, rating, emoticons, bookmark, report.

The other object of the present invention is to directly identify prospective customers and real-time connect and communicate with prospective customers, ask queries, provide answers to their queries, convey them, present required products and services, understand terms and conditions, negotiate with them and close sales and deals.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein enabling user(s) to receiving one or more keywords, selections of criteria, filters, operators, brief or agenda or subject, settings and any combination thereof from at least one user of a first plurality of users including from a first computing device of a first user; determining one or more queries based on at least one of a keywords, selections of criteria, filters, operators, brief or agenda or subject, settings and any combination thereof; processing data stored in a data store based on at least one query of the one or more queries to identify a second plurality of users; displaying, to a first computing device of a first user, information about a second plurality of users; enabling to a first user to select list item(s) from displayed list of a second plurality of users; enabling to a first user to send request to connect to said each selected list item associated user; in the event of acceptance of connection request by said request receiver user or requestee or automatically accept connection request settings provided by requestee, establishing connection or initiating communication session between first user and each request accepted user.

In an embodiment receive digital content from at least one user of a first plurality of users including from a first computing device of a first user, wherein digital content comprise one or more types of requirements and each type of requirement specific one or more types of details; maintaining digital content including one or more types of requirements and each type of requirement specific one or more types of details; receiving request to search selected one or more types of requirement specific users of network; searching, matching and identifying said request specific second plurality of users based on matching said received request with maintained one or more types of requirements and each type of requirement specific one or more types of details; displaying, to a first computing device of a first user, information about a second plurality of users; enabling to a first user to select list item(s) from displayed list of a second plurality of users; enabling to a first user to send request to connect to said each selected list item associated user; and in the event of acceptance of connection request by said request receiver user or requestee or based on automatically accept connection request settings provided by requestee, establishing connection or initiating communication session between first user and each request accepted user, wherein maintaining one or more types of requirements and each type of requirement specific one or more types of requirement specification or product or service specification or details or digital cements or data from plurality of users. Types of requirement comprise needs or interested to buy one or more types of one or more products and/or services, require one or more types of freelancers, need one or more types of outsourcing services, interested in business partnerships, franchisee, distributorships, marketing of products or services, need one or more types of consultancies, require to raise finance, post jobs or need job seekers, want to contracts, assign tasks, works, projects, assignments. In an embodiment search criteria or filter comprise keywords, one or more types or categories or sub-categories of products, services, tasks, works, jobs, assignments, projects, consulting, professionals services including travel, transport, couriers, finance, loans, insurance, health and medicines, health report services, doctors, foods, caterers, teachers or tutors or trainers, entertainments, tickets, books, gifts, on demand services, houses or homes, sports, events, repairs, hire, one or more types of services and products, contracts, range of qualities, range of amounts, price range, associated terms and conditions, associated required services, type of features, specification associate keywords or structured details including one or more fields associate values, one or more types and names of companies, geography or locations including location range, geo-fence boundaries, selected places on map, address, postal code, location or place types, type of inductors, relationships, company size, function, title including CEO, founder, years at current company, year in current position, name, profile language, years of experience, seniority level, one or more types of fields and associate selected or inputted values or data and one or more types of settings comprise search users who are online, offline, free, paid, provide number of connections requirements, type of connections requirements including users who are in requesting or searching user's contacts, contacts or contacts, liked, bookmarked, rated users, ranked users of network or any users of network.

In an embodiment receive digital content from at least one user of a first plurality of users including from a first computing device of a first user, wherein digital content comprise one or more types of requirements and each type of requirement specific one or more types of details; maintaining digital content including one or more types of requirements and each type of requirement specific one or more types of details; receiving request to search selected one or more types of requirement specific users of network; searching, matching and identifying said request specific second plurality of users based on matching said received request with maintained one or more types of requirements and each type of requirement specific one or more types of details; displaying, to a first computing device of a first user, information about a second plurality of users; enabling to a first user to select list item(s) from displayed list of a second plurality of users; enabling to a first user to send request to connect to said each selected list item associated user; and in the event of acceptance of connection request by said request receiver user or requestee or based on automatically accept connection request settings provided by requestee, establishing connection or initiating communication session between first user and each request accepted user, wherein maintaining one or more types of requirements and each type of requirement specific one or more types of requirement specification or product or service specification or details or digital cements or data from plurality of users. Types of requirement comprise needs or interested to buy one or more types of one or more products and/or services, require one or more types of freelancers, need one or more types of outsourcing services, interested in business partnerships, franchisee, distributorships, marketing of products or services, need one or more types of consultancies, require to raise finance, post jobs or need job seekers, want to contracts, assign tasks, works, projects, assignments.

In an embodiment receiving and maintaining job profiles of users of network; receiving and maintaining job posts from recruiters; matching job profiles with job posts to identifying matched recruiters for each job profile; displaying information about matched job posts and associate recruiters to each matched job seeker; enabling to a job seeker to select list item(s) from displayed list of job posts and associate recruiters; enabling to a job seeker to send request to connect to one or more selected list item associated recruiters; and in the event of acceptance of connection request by said request receiver user or requestee or automatically accept connection request settings provided by requestee, establishing connection or initiating communication session between first user and each request accepted user.

In an embodiment receiving and maintaining job profiles of users of network; receiving and maintaining job posts from recruiters; matching job profiles with job posts to identifying matched job seekers for each job post; displaying information about matched job seekers to each matched job post associate recruiter; enabling to a recruiter to select list item(s) from displayed list of a job seekers; enabling to a recruiter to send request to connect to one or more selected list item associated jobseekers; and in the event of acceptance of connection request by said request receiver user or requestee or automatically accept connection request settings provided by requestee, establishing connection or initiating communication session between first user and each request accepted user.

In an embodiment receiving and maintaining a job profile from a job seeker; receiving and maintaining an indication from a job seeker regarding interested to looking for jobs; receiving and maintaining one or more job posts from a recruiter; receiving and maintaining an indication from recruiter regarding interested to identify and view each job post specific matched contextual job profiles of jobseekers; searching, matching and identifying each job post of said recruiter specific matched contextual job profiles of jobseekers; displaying, to a computing device of a recruiter, information about a second plurality of users; enabling to a recruiter to select list item(s) from displayed list of a job seekers; enabling to a recruiter to send request to connect to one or more selected list item associated jobseekers; and in the event of acceptance of connection request by said request receiver user or requestee or automatically accept connection request settings provided by requestee, establishing connection or initiating communication session between first user and each request accepted user. In an embodiment each list item of list of second plurality of users comprise title, logo or icon, date of job posted, location, company name, abstract of job post, salary or salary range, job type including full time, part time, internship, temporary, and contract, locations, company, industry, job function, experience level including internship, entry level, associate, mid-senor level, director, executive, position, skills required, educations, experiences, online or offline availability or presence information or recruiter, ratings, type of user including in contact, in contact of contact, liked, saved, rated, bookmarked user by requesting user, verified or certified user, referred user, payment require to connect or free and enabling searching or requesting user or viewing user of search results to sort or filter displayed list of a second plurality of users, wherein sort based on ratings, liked, bookmarked, online available, offline, free, paid users of network, user's contact or contacts of contacts, past connected users, in past not connected users or new users and any combination thereof and filter comprise particular rating of users, liked, saved, bookmarked, online available, offline, free, paid users of network, user's contact or contacts of contacts, past connected users, in past not connected users or new users and any combination thereof. In an embodiment search criteria or filter comprise keywords, categories, types, date of job posted including past 24 hours, past week, past month and any time, salary or salary range, job type including full time, part time, internship, temporary, and contract, locations, company, industry, job function, experience level including internship, entry level, associate, mid-senor level, director, executive, one or more types of fields and associate selected or inputted values or data and one or more types of settings comprise search users who are online, offline, free, paid, provide number of connections requirements, type of connections requirements including users who are in requesting or searching user's contacts, contacts or contacts, liked, bookmarked, rated users, ranked users of network or any users of network.

In an embodiment in the event of ending of communication session by invitor and/or invitee or triggering of one or more pre-defined rules or expiration of pre-set duration timer, end communication session and end connection between invitee and invitor, wherein timer starts from when communication session initiated or established and ends when pre-set duration associated with timer expired.

In an embodiment notifying invitor about receiving of connection request, wherein notification comprise requirement specification or brief or agenda or subject or type of task provided by invitee, accept option or control to enable invitor to accept connection request, ignore or reject or cancel option or control to enable invitor to ignore or reject or cancel connection request, schedule connection option or control to enable invitor to provide schedule to establish connection between invitor and invitee and payment required to connect option or control to enable invitor to ask invitee to make payment to enable invitor to accept connection request of invitee.

In an embodiment after acceptance of connection request by invitor and establishment of connection between invitor and invitee, automatically displaying or enabling to select one or more types of one or more interfaces, applications, widgets, webpage, website to both invitor and invitee, wherein interfaces, applications, widgets, webpage, website may comprise instant messenger or chat application, e-mail application, short message service (SMS) application, collaboration application to enable invitee or requestor to communicate or collaborate with one or more request accepted users or connected users, e-commerce or transaction application, social network application, task, workflow and event planning and management application.

In an embodiment after acceptance of connection request by invitor and establishment of connection between invitor and invitee, charges invitee based on one or more payment or pricing models including pay per connection model, wherein invitee automatically charge from one or more payment methods including payment wallet or can make payment by using one or more payment methods or instructing invitee to make payment by using one or more payment methods.

In an embodiment in the event of ignore of connection request by invitor or requestee, notify invitee about ignoring or cancellation or rejection of connection request.

In an embodiment in the event of scheduling connection establishment by invitor or requestee, establishing connection as per schedule of invitor or notifying invitee about schedule and in the event of acceptance of schedule by invitee, establishing connection as per schedule or in the event of rejection of schedule, cancel request or in the event of providing different schedule by invitee, notifying invitor about said schedule and in the in the event of acceptance of schedule by invitor or requestee, establishing connection as per schedule or in the event of rejection of schedule cancel request.

In an embodiment in the event of payment require to connect option selected by invitor, notify invitee about charges and enable invitee to view charges provided by inviter and make payment to invitor or requestee or ignore or cancel request to connect and in the event of making payment by invitee, invitor or requestee can accept or accept and schedule connection and in the event of non-acceptance of connection request within pore-set duration reimburse said payment to invitee.

In an embodiment each list item of list of second plurality of users comprise title, location, current or past companies, position, skills, educations, experiences, online or offline availability or presence information, ratings, type of user including in contact, in contact of contact, liked, rated, bookmarked user by requesting user, verified or certified user, referred user, payment require to connect or free and enabling searching or requesting user or viewing user of search results to sort or filter displayed list of a second plurality of users, wherein sort based on ratings, liked, bookmarked, online available, offline, free, paid users of network, user's contact or contacts of contacts, past connected users, in past not connected users or new users and any combination thereof and filter comprise particular rating of users, liked, bookmarked, online available, offline, free, paid users of network, user's contact or contacts of contacts, past connected users, in past not connected users or new users and any combination thereof.

In an embodiment search criteria or filter comprise title, one or more current or past companies, schools, colleges, locations including location range, geo-fence boundaries, selected places on map, address, location or place types, type of inductors, profile languages, keywords, one or more types of fields and associate selected or inputted values or data and one or more types of settings comprise search users who are online, offline, free, paid, provide number of connections requirements, type of connections requirements including users who are in requesting or searching user's contacts, contacts or contacts, liked, bookmarked, rated users, ranked users of network or any users of network.

In an embodiment searching or requesting user can prepare request to real-time search users of network as per user's requirement, wherein request comprise search query, criteria, selections, filters and settings to search users of network. Based on said request server displays request specific users of network. Searching user selects one or more users from search results and tap on “Connect” button to real-time send invitation to connect to communicate with them. In the event of acceptance of request to connect to communicate by requestee, enable both to communicate with each other (Request contains subject, so requestee can decide whether to accept request or not—Requestee can accept connection if payment done by requestor—ignore if not relevant or schedule connection based on time availability of requestee or on-demand request specific charge fees for connecting with requestor). There is no mutual connection happens. Only temporarily both are connected and in the event of ending of conversation both are disconnected with each other. Both said temporarily connected users can provide like, dislike, rating, bookmark, comment, view profile, share contact information, and report on each other. Since no connection management, user can real-time search and then send request to connect to communicate to selected users from search results who are ready to reply to user

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a network diagram depicting a network system having a client-server architecture configured for exchanging data over a network implementing various embodiments of selecting users from request specific identified users and connecting with users who accepted request related system.

FIG. 2 illustrates components of an electronic device implementing various embodiments of selecting users from request specific identified users and connecting with users who accepted request related system.

FIG. 3 illustrates example system for verifying user wherein user can provide mobile number and system sends One Time Password (OTP) via short message (SMS). System atomically verifying the One Time Password (OTP) sends to said user provided mobile number and then registering user with network.

FIG. 4 illustrates example system for enabling a user to capture one or more photos or select images or photos or video or screenshots of user profile from one or more external sources and uploads, sends to server, wherein server recognized and identified one or more types of structured contents including profile photo, name, education, skills, experience, positions, contact information in photo via Optical Character Recognition (OCR) and Object recognition and stores in relational database. So user can easily import profile from one or more external sources and instantly starts using system.

FIG. 5-7 illustrates example profile of user and one or more types of user related data or contents, wherein profile may comprises profile photo, name, education, skills, experience, positions, contact information and settings. User can import contacts from one or more sources.

User can provide presence information, status, updates, checked-in place, and location information. User can provide likes, ratings, comments to other users of network. User can manage, view, update, apply privacy settings and publish profile and contents.

FIG. 8 illustrates example Graphical User interface (GUI) for enabling user to provide various types of settings.

FIGS. 9-10 illustrates example Graphical User interface (GUI) enabling user to search other users of network based on search query, keywords, categories, types, selected keywords from auto fill-ups suggested contextual keywords, selected one or more criteria, conditions, fields and associated one or more types of values or data or content, settings, sort types, requirement specification or query or task specification or agenda or subject of connection requirement.

FIG. 11 illustrates example Graphical User interface (GUI) displaying search results based on searching or requesting user's search query, keywords, criteria, settings and requirement specifications. User can sort, filter, view search results, view search result associate profile and select one or more search result and can click or tap on connect to send request for connection to said user selected one or more search results associated users. Request receiving user can ignore, accept and schedule request or instruct requestor to make payment to connect with user.

FIG. 12 illustrates example Graphical User interface (GUI) enabling connected users to communicate with each other.

FIG. 13 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

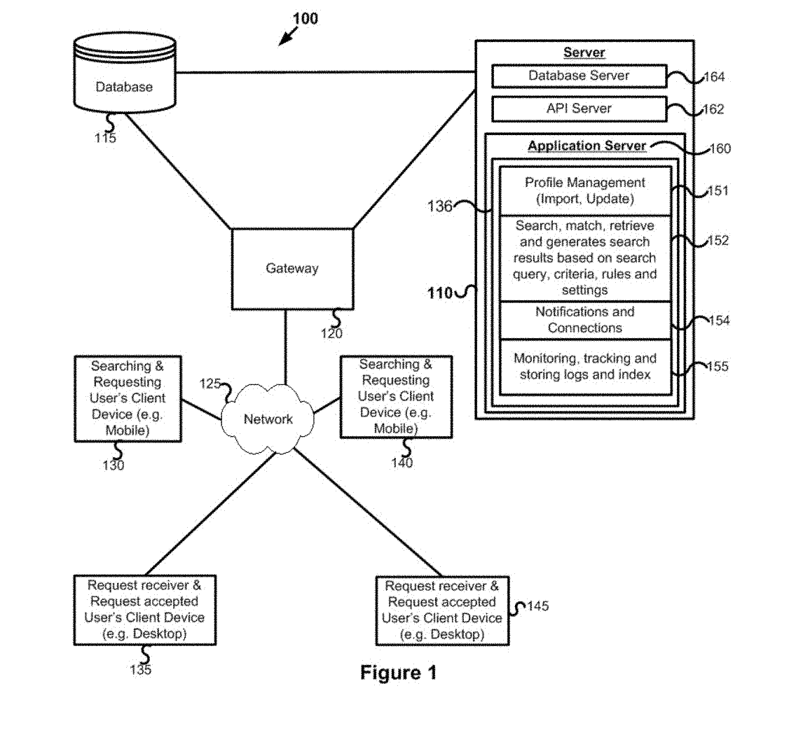

FIG. 1 illustrates an example user to user connection platform, under an embodiment. According to some embodiments, system 100 can be implemented through software that operates on a portable computing device, such as a mobile computing device 110. System 100 can be configured to communicate with one or more network services, databases, objects that coordinate, orchestrate or otherwise provide shared, published, send, received contents of each user to other users of network. Additionally, the mobile computing device can integrate third-party services which enable further functionality through system 100.

The system for enabling user to user connection platform for enabling user to prepare and send request to connect, wherein server searches and matches request specific users of network and displays to user for user selection. User selects one or more list items and send request to connect to selected list item associated users of network. Server sends notification to selected list item associated users of network, wherein notification receiving users receives and views said notification and enable to tap or click on notification associated ignore or cancel or reject button to reject request to connect or tap or click on accept button to accept request to connect. In an embodiment in the event of acceptance of request both user is presented with or enable to select one or more types of applications including instant messenger, so they can communicate with each other. In an embodiment in the event of ending of current communication session by tapping or clicking on “End” button, system or server ends current communication session between connected users, so both are dis-connected with each other and not communicate with each other. In an embodiment after ending current communication session, enabling both users to save conversations locally or at one or more external databases or servers or devices. In an embodiment after ending current communication session, system or server removes conversations after expiration of pre-set duration, so meanwhile user can save conversations locally or at one or more external databases or servers or devices. In an embodiment pre-set duration set or update by server or requesting user or request accepted user or pre-set duration is default setting. In an embodiment after ending current communication session, system or server removes conversations. In an embodiment after ending current communication session, system or server stores indexes of said conversations and then removes conversation based on expiration of pre-set duration. In an embodiment expiration timer starts from ending of communication session and ends at expiration of pre-set duration. While FIG. 1 illustrates a gateway 120, a database 115 and a server 110 as separate entities, the illustration is provided for example purposes only and is not meant to limit the configuration of the user to user connection system. In some embodiments, gateway 120, database 115 and server 110 may be implemented in the user to user connection system as separate systems, a single system, or any combination of systems.

As illustrated in FIG. 1, the user to user connection system may include a requesting user device or mobile devices 130/140 and request accepted user device or mobile devices 135/145. Devices or Mobile devices 130/140/135/145 may be particular set number of or an arbitrary number of devices or mobile devices which may be capable of enabling user to prepare request, send request to server and receive and display said request specific searched, matched and retrieved information about users of network, select search result from displayed search results and send request to connect with said selected search result associated users, receive notifications of requestors, accept request to connect, ignore request to connect, schedule request to connect and ask for payment to connect with requestor, provide various types of notifications to requesting user including request to connect rejected, request to connect accepted, request to connect scheduled, payment required for connecting with requestor, communicate, collaborate, share, participate, transact with each other via one or more applications including instant messenger. Each device or mobile device in the set of requesting user(s) 130/140 and request receiver or request accepted user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the user to user connection system may include gateway 120. Gateway 120 may be a web gateway which may be configured to communicate with other entities of the user to user connection system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of user to user connection system. In various embodiments, gateway 120 may be connected to database 115 and/or server 110 via a wired or a wireless network connection.

Gateway 120 may be configured to send and receive requests, search results, notifications, shared contents or data, wherein user data comprises user requests, user profile, user connections or contacts, connected users' data, user shared data or contents, user's logs, monitored or tracked information about user's one or more types of activities, actions, events, senses, transactions, status, updates, presence information, locations, check-in places and like to/from mobile devices 130/140/135/145. For example, gateway 120 may be configured to receive requests to search users of network or receive requests to connect said selected search result associated users to database 115 for storage.

As another example, gateway 120 may be configured to send or present request specific searched or matched information about users of network or search results to requestor from stored database 115 to mobile devices 130/140/135/145. Gateway 120 may be configured to receive search requests or connection request from mobile devices 130/140/135/145 for searching and presenting request specific users or send notification to request to connect associated users.

For example, gateway 120 may receive a request from a mobile device and may query database 115 with the request for searching and matching request specific users of network. Gateway 120 may be configured to inform server 110 of updated data. For example, gateway 120 may be configured to notify server 110 when a new search requests to search request specific users or connection request to connect with request to connect associated users has been received from a mobile device or device of requestor user stored on database 115.

As illustrated in FIG. 1, the user to user connection system may include a database, such as database 115. Database 115 may be connected to gateway 120 and server 110 via wired and/or wireless connections. Database 115 may be configured to store a database of registered user's profile, accounts, logged activities, indexes of conversations, one or more types of user related or associated data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, user account's related data which meet the criteria specified in the request. Database 115 may be configured to communicate with server 110.

As illustrated in FIG. 1, the user to user connection system may include a server, such as server 110. Server may be connected to database 115 and gateway 120 via wired and/or wireless connections. As described above, server 110 may be notified, by gateway 120, of new or updated user requests including search request and connection request, user profile, user data, user posted or shared or send contents, user contacts and various types of status stored in database 115.

In another embodiment the system for connecting requesting user with request specific users or requestor user determined users of network and enabling connected users to communicate with each other (discussed in detail in figures) may be referred to herein, for simplicity, as the “user to user connection system.” FIG. 1 illustrates a block diagram of a user to user connection system configured to implement the platform where user(s) can search other users of network based on search query, one or more criteria, and settings and select from search results one or more users and send request to connect to them for connecting with them and communicating with connected users and in the event of acceptance of request to connect by request receiving user, requestor is connected with said request accepted one or more users and enabling to communicate with them. While FIG. 1 illustrates a gateway 120, a database 115 and a server 110 as separate entities, the illustration is provided for example purposes only and is not meant to limit the configuration of the user to user connection system. In some embodiments, gateway 120, database 115 and server 110 may be implemented in the user to user connection system as separate systems, a single system, or any combination of systems.

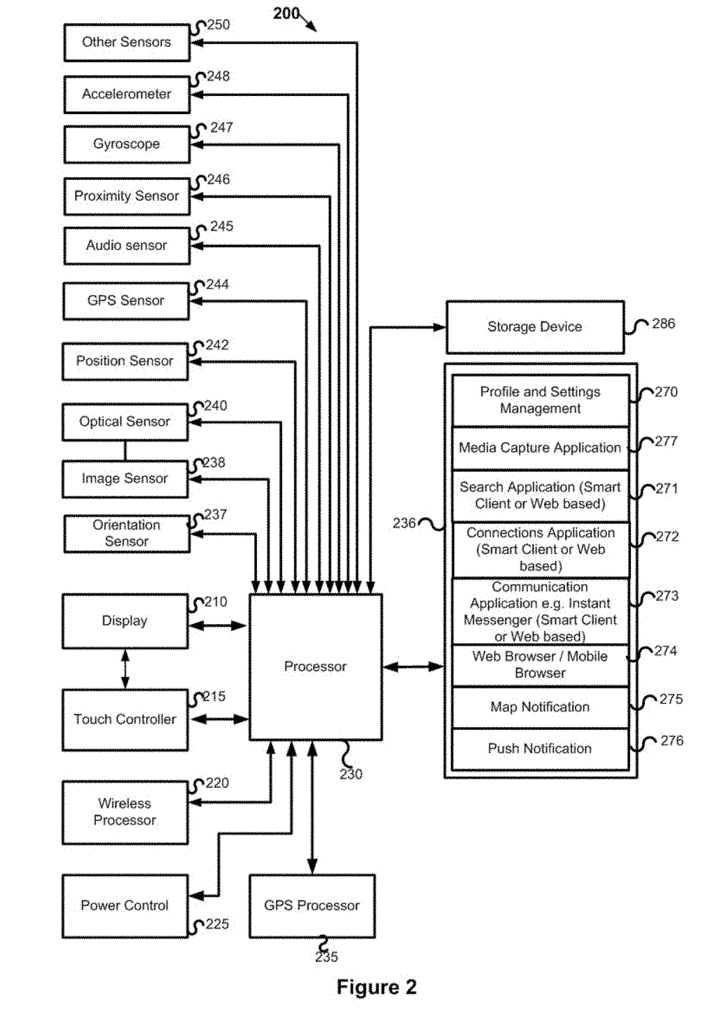

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores profile management application (Smart Client or Web based) 270 to implement operations of one of the embodiment of the invention. The profile management application (Smart Client or Web based) 270 may include executable instructions to access a client device and/or a server which coordinates operations disclosed herein. Alternately, the profile management application (Smart Client or Web based) 270 may include executable instructions to coordinate some of the operations disclosed herein, while the server implements other operations.

The memory 236 stores a Media Capture Application (Smart Client or Web based) 277 to implement operations of one of the embodiment of the invention. The Media Capture Application (Smart Client or Web based) 277 may include executable instructions to access a client device and/or a server which coordinates operations disclosed herein. Alternately, the Media Capture Application (Smart Client or Web based) 277 may include executable instructions to coordinate some of the operations disclosed herein, while the server implements other operations. The memory 236 stores a Search Application (Smart Client or Web based) 271 to implement operations of one of the embodiment of the invention. The Search Application (Smart Client or Web based) 271 may include executable instructions to access a client device and/or a server which coordinates operations disclosed herein. Alternately, the Search Application (Smart Client or Web based) 271 may include executable instructions to coordinate some of the operations disclosed herein, while the server implements other operations. The memory 236 stores a Connections Application (Smart Client or Web based) 272 to implement operations of one of the embodiment of the invention. The Connections Application (Smart Client or Web based) 272 may include executable instructions to access a client device and/or a server which coordinates operations disclosed herein. Alternately, the Connections Application (Smart Client or Web based) 272 may include executable instructions to coordinate some of the operations disclosed herein, while the server implements other operations. The memory 236 stores a Communication Application (Smart Client or Web based) 273 to implement operations of one of the embodiment of the invention. The Communication Application (Smart Client or Web based) 273 may include executable instructions to access a client device and/or a server which coordinates operations disclosed herein. Alternately, the Communication Application (Smart Client or Web based) 273 may include executable instructions to coordinate some of the operations disclosed herein, while the server implements other operations. The memory 236 stores a Web Browser/Mobile Browser 274 to implement operations of one of the embodiment of the invention. The Web Browser/Mobile Browser 274 may include executable instructions to access a client device and/or a server which coordinates operations disclosed herein. Alternately, the Web Browser/Mobile Browser 274 may include executable instructions to coordinate some of the operations disclosed herein, while the server implements other operations. The memory 236 stores a Map Application 275 to implement operations of one of the embodiment of the invention. The Map Application 275 may include executable instructions to access a client device and/or a server which coordinates operations disclosed herein. Alternately, the Map Application 275 may include executable instructions to coordinate some of the operations disclosed herein, while the server implements other operations. The memory 236 stores a Push Notification Application 276 to implement operations of one of the embodiment of the invention. The Push Notification Application 276 may include executable instructions to access a client device and/or a server which coordinates operations disclosed herein. Alternately, the Push Notification Application 276 may include executable instructions to coordinate some of the operations disclosed herein, while the server implements other operations. The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the search application 271, connection application 272 and communication application 273 operating in conjunction with a server.

FIG. 2 shows a block diagram illustrating one example embodiment of a mobile device 200. The mobile device 200 includes an optical sensor 240 or image sensor 238, a Global Positioning System (GPS) sensor 244, a position sensor 242, a processor 230, a storage 236, and a display 210.

The optical sensor 240 includes an image sensor 238, such as, a charge-coupled device. The optical sensor 240 captures visual media. The optical sensor 240 can be used to media items such as pictures and videos.

The GPS sensor 244 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 238 of the mobile device is pointed and an orientation sensor 237 to determine the orientation of the mobile device (e.g., horizontal, vertical etc.).

The processor 230 may be a central processing unit that includes a media capture application 277.

The media capture application 277 includes executable instructions to generate media items such as pictures and videos using the optical sensor 240 or image sensor 238. The media capture application 277 also associates a media item with the geolocation and the position of the mobile device 200 at the time the media item is generated using the GPS sensor 244 and the position sensor 242.

The storage 236 includes a memory that may be or include flash memory, random access memory, any other type of memory accessible by the processor 230, or any suitable combination thereof. The storage 236 stores the media items generated or shared or received by user and also store the corresponding geolocation information, auto identified system data including date & time, auto recognized objects in photo or image(s) of video associated keywords, metadata, and user provided information. The storage 236 also stores executable instructions corresponding to

the Search Application (Smart Client or Web based) 271, Connections Application (Smart Client or Web based) 272, Communication Application (Smart Client or Web based) 273, Web Browser/Mobile Browser 274, Map Application 275 and Push Notification 276.

The display 210 includes, for example, a touch screen display. The display 210 displays the media items generated by the media capture application 277. A user captures, records and selects media items for importing or preparing profile in the form of photo or image from one or more sources to convert it to structured data via Optical Character Recognition (OCR) by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

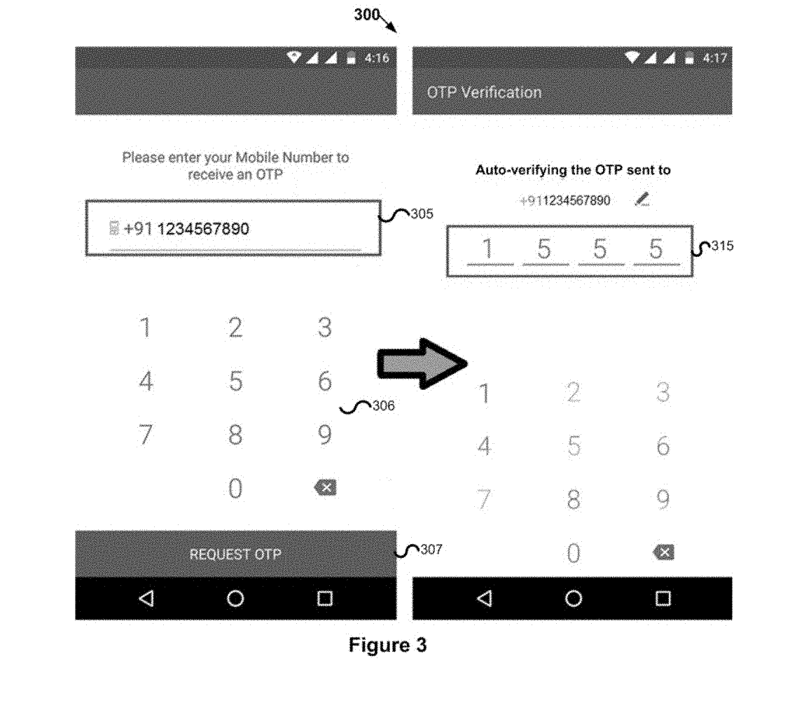

FIG. 3 illustrates example Graphical User Interface (GUI), wherein in an embodiment after downloading and installing application which comprise profile management application 270, media capture application 277, search application 271, connections application 272, communication application 273, for registration, user is instructed to provide user's mobile number 305 to receive an One Time Password (OTPs) via requesting 307 One Time Password (OTPs), where a message is sent by the service-provider and it 315 is automatically read by the application, verifying it. Main advantage of mobile number verification is to identify each user in application uniquely. Server 110 or service provider can do mobile number verification by sending a One Time Password (OTPs) to the mobile 300 which is using application. System reads short message service (SMS) automatically and automatically verifies the One Time Password (OTPs) 315.

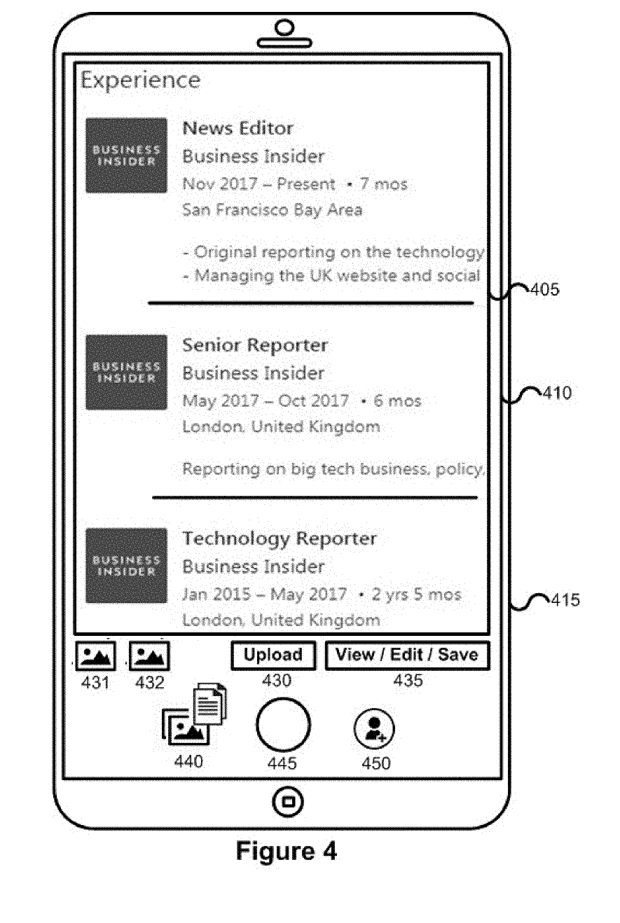

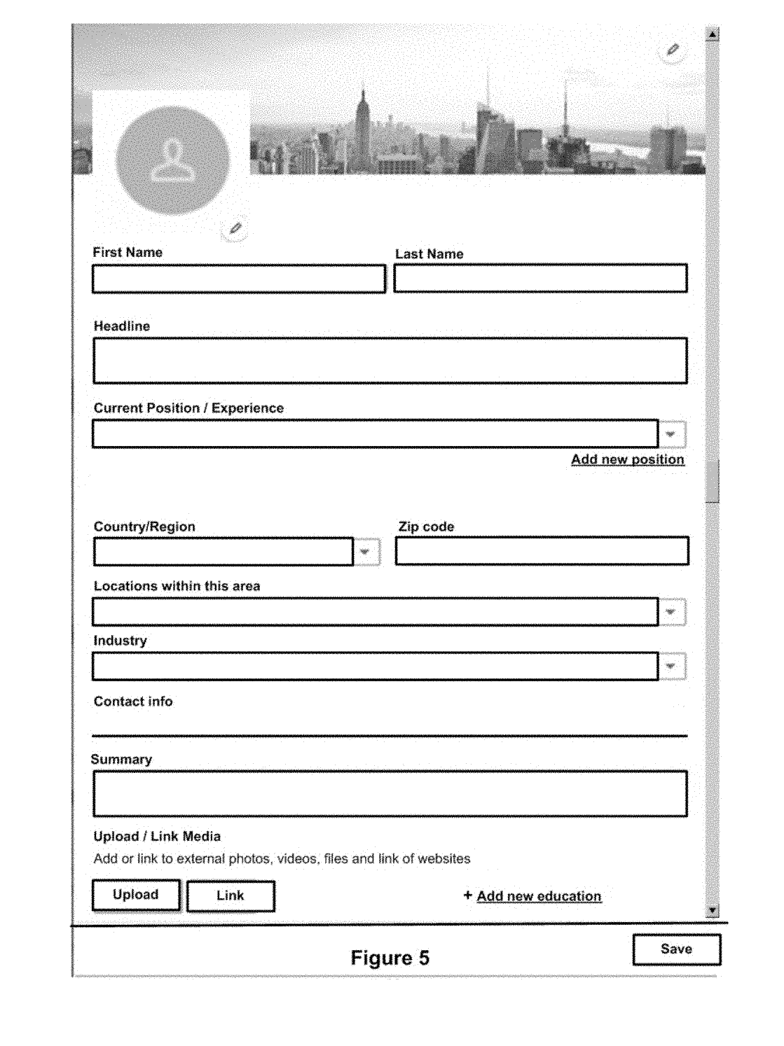

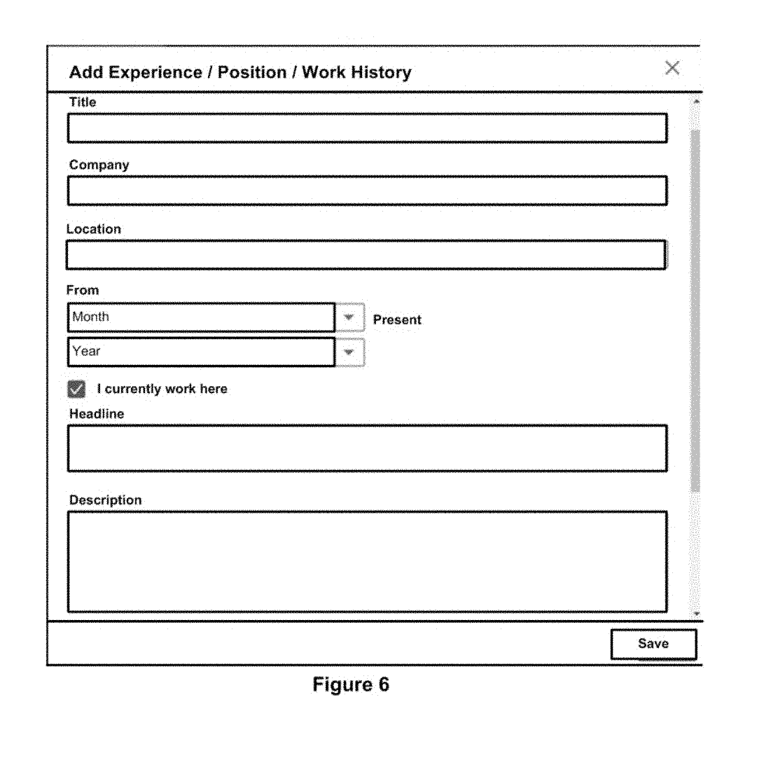

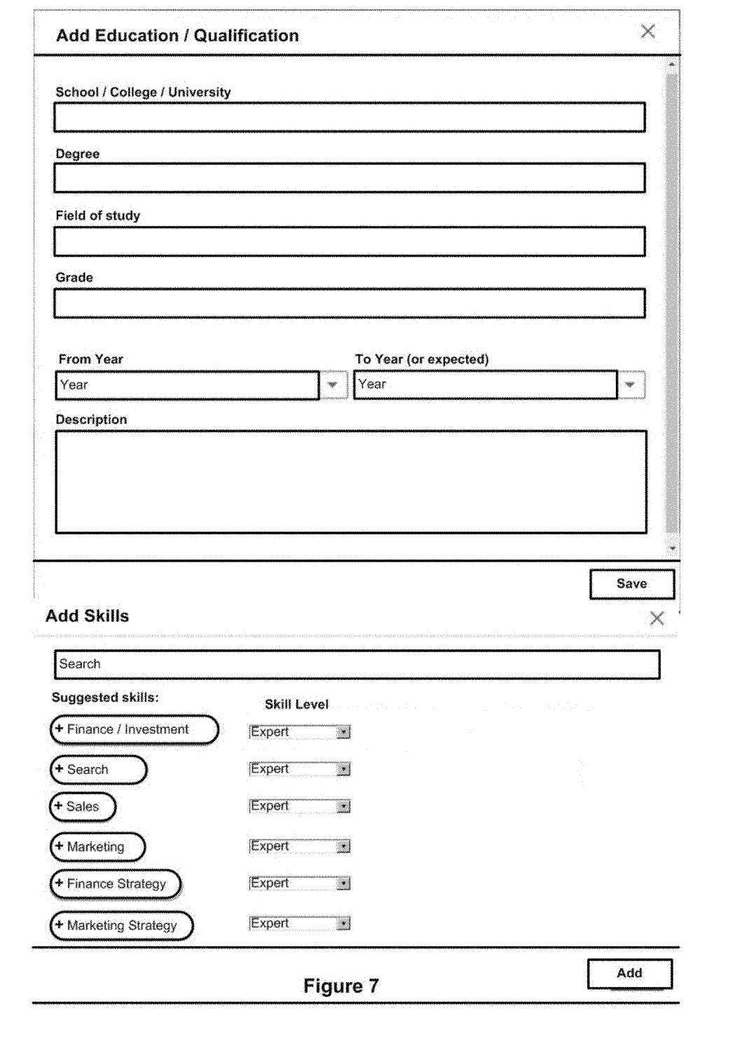

FIG. 4 illustrates example Graphical User Interface (GUI) 270 for enabling user to import user's one or more types of profile from one or more external sources. By using media capture application 277, user can capture one or more images (e.g. 405) or photos (e.g. 405) or record video 405 of profile display on webpage or application or Graphical User Interface (GUI) by tapping or clicking on “Capture” icon 445 on camera screen 410 from user device 415. After capturing of image or photo or recording of video, each captured photo or image or recorded video 431/432 displays to user on camera screen 410 for viewing. User can tap or click on thumbnail 431/432 of captured photo or image or recorded video (e.g. 405) to view or review profile and can upload to server module 151 of server 110. In an embodiment user can select images of photos or video of profile from photo or video library of user device by tapping or clicking on select photos or videos icon 440 and can upload to server module 151 of server 110. Server module 151 receives said uploaded images or photos or video of profile from user device 415 and process said received profile photos or images or video by employing Optical Character Recognition (OCR) or Character recognition technologies to identify text in photo or image or video including first name, last name, current position, locations, industry, current company, industry, contact information including email and phone number, experience, education, skills, details and like. In an embodiment server module 151 of server 110 also recognize or identifies and extracts photo of user or icon or logos of companies from said received profile photos or images or video by employing object recognition technology or face recognition technology or body parts recognition technology. In an embodiment human mediation may employed for identifying, editing, correcting text data from said received profile photos or images or video. In an embodiment server module 151 of server 110 stores said identified data including field name and associated value or data to relational database 115. In an embodiment server module 151 of server 110 displays said stored data to user in structured forms (discuss in details in FIGS. 5-7) for viewing, editing, correcting, updating and saving to database 115 of server 110 via button 435. Based on profile structure, server module 151 of server 110 identifies associated schema and based on schema (e.g. headings, sequences, delimiter, font size, color, type) identifies field name based on data or value and store said data or value to associated identified field and stores to relational database 115. In an embodiment user can select profile management icon 450 to prepare or update profile by using said identified data and various forms (discuss in details in FIGS. 5-7). In an embodiment user can send or upload via upload button 430, saved profile of user in one or more types of file format including .PDF, .Doc, .TXT or webpage format to server module 151 of server 110, server module 151 of server 110 transforms profile data from said format to relational data and store to database 115 and displays to user to review, correct, edit and save edited said transformed profile. After uploading, transforming, reviewing, editing and saving said profile, user can any time update said profile from structured profile forms (discuss in detail in FIGS. 5-7). Server module 151 of server 110 receives one or more types of updated profiles, user data including status, presence information, current or checked-in or selected one or more locations or places, updates, imported contacts and settings via forms (some of the example forms shown in FIGS. 5-8) from user and stores to server database 115 for later retrieval.

FIGS. 5-7 illustrates example Graphical User Interface (GUI) 270 for managing, viewing, preparing and updating user's one or more types of profile including professional profile, business profile, company profile, social network profile, job profile, general profile, expert profile, product and service profile and details and like. FIGS. 5-7 illustrates some of the example of user profile wherein user can provide Name (First & Last), Photo, Headline, Current Position, Location information, Industry, contact information including Email, Mobile phone number and address, Summary, Experience (Job Title/Company/Location/From-To/Headline/Indication of Currently work here or not/Update Industry/Headline/description), Education (School, Degree, Field of study, Grade, From Year, To Year (expected) and description), Skills including search, select from suggested and add one or more types of skills, Uploaded Media, Accomplishments (e.g. Patent, Publication, Certification, Course, Project, Honor and Award, Test Score, Language, Organization, Interests) and like.

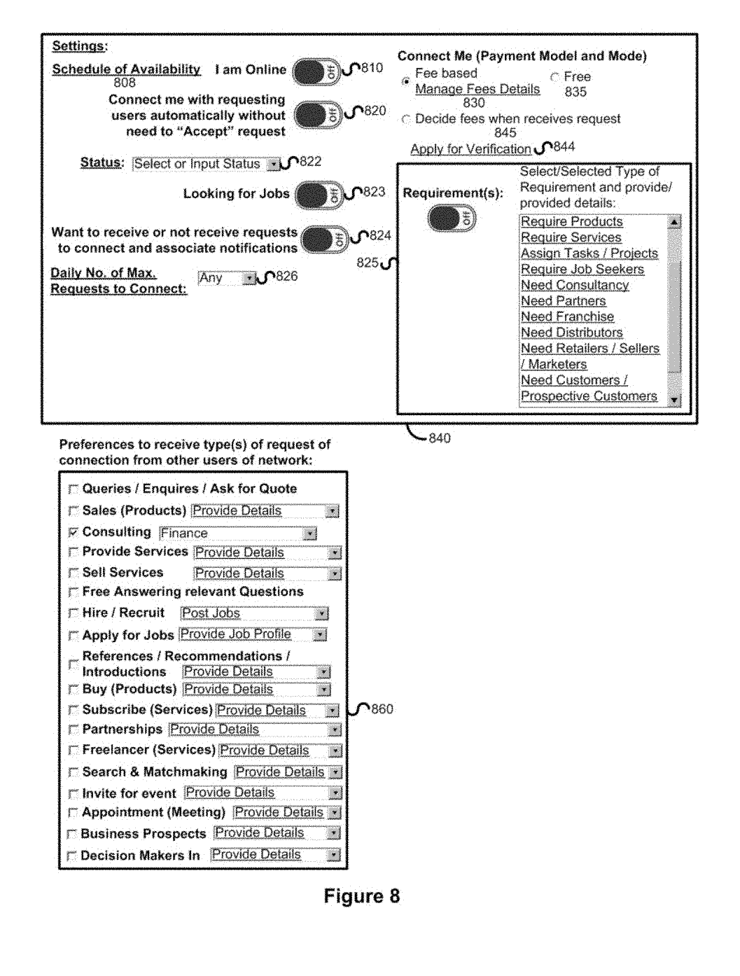

FIG. 8 illustrates example Graphical User interface (GUI) 270 for enabling user to provide various types of settings including set online or offline status 820, set or provide user's current status 822, set user want to looking for job or not 823, whether user want to receive or not receive requests and associate notifications 824, receive daily number of maximum requests to connect 826, set requirement as ON and disclose one or more types of requirements including product, service, job and consultancy requirements and associate provide details 825, set or provide presence information, updates, checked-in place or location & activity information and associate information (not show in figure), provide availability schedules or timings (Date & Time, Day wise Timings) of availability 808, provide Type of payment models and mode details 830 including pre-defined packages or rules, hourly base fees, per message or query fees, type specific fees or custom charges or free 835, select option “Decide fees when receive request” 845 if user want to decide about fees at the time of receiving and viewing of request of requestor, set option 820 to connect user automatically with requestor or connect user automatically with requestor when user is online or when application is open or notifying user about connection request of requestor and enable user to tap on notification to start conversation with requestor. User can provide preferences 860 for connecting user by other users of network including one or more types of request for that other users of network wants to connect with user, wherein types of request comprise Query to ask answer of query, ask quote, enquiry, want to sale, market, distribute, need reference or recommendation of customers, want to buy one or more types of products and services, apply for particular type of job or apply for particular type of job at particular company, hire personals, partnerships or mediation for partnerships or consulting or reference for partnerships, want to consume service, want to assign periocular types of tasks, work, project, want to become client, search or match particular types of services, products, job seekers, professional, partners, customers, prospective customers, clients, members, viewers, readers, listeners.

In an embodiment user can apply 844 for one or more types of user verification service, wherein user's profile including user's one or more types of identities and contacts information like name, photo, home and work address or location, phone number, email address, languages, education and qualification, positions and experience including company name, potion and number of year of experience, skills are verified by employing one or more verification services, systems and methods including external verification service providers.

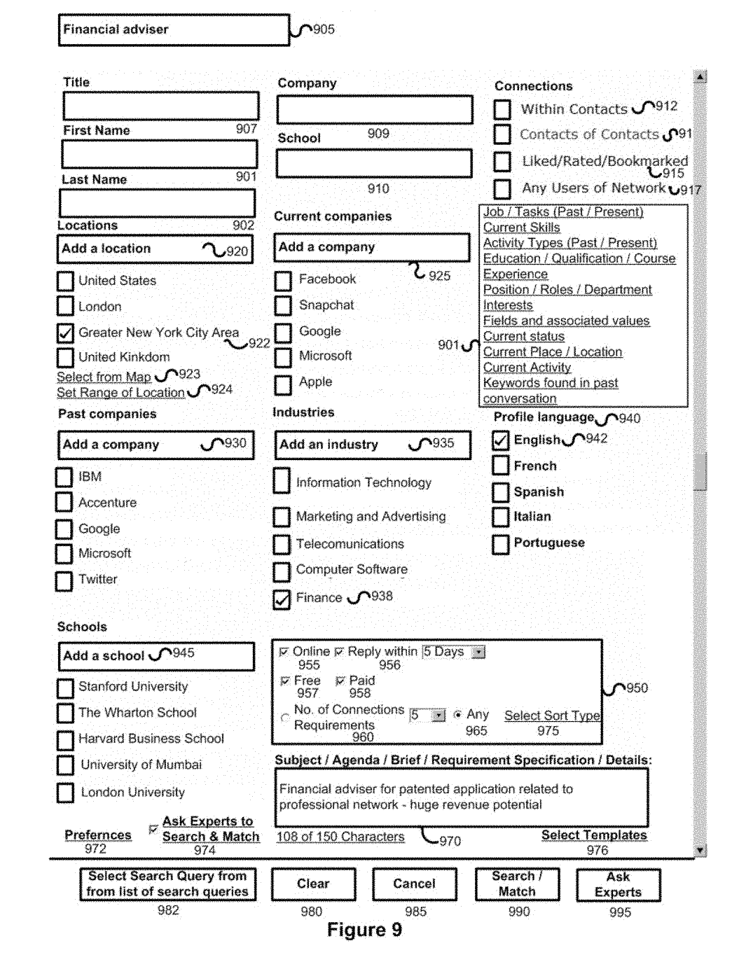

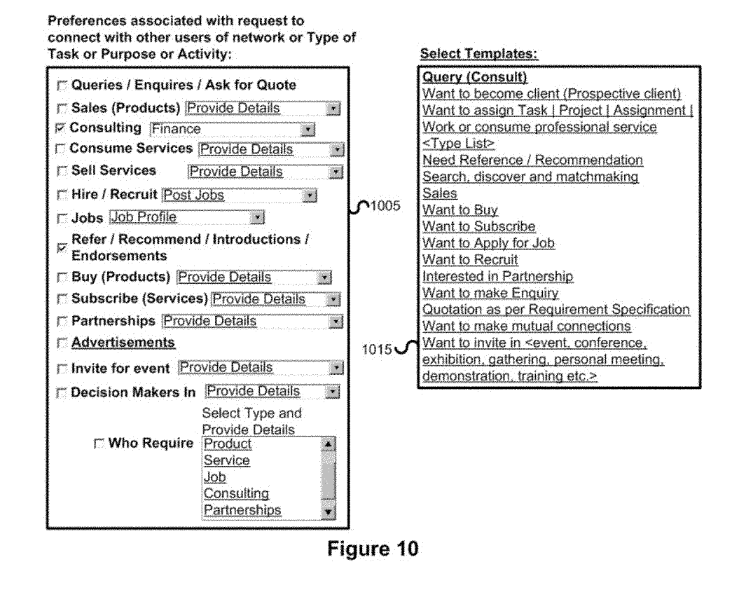

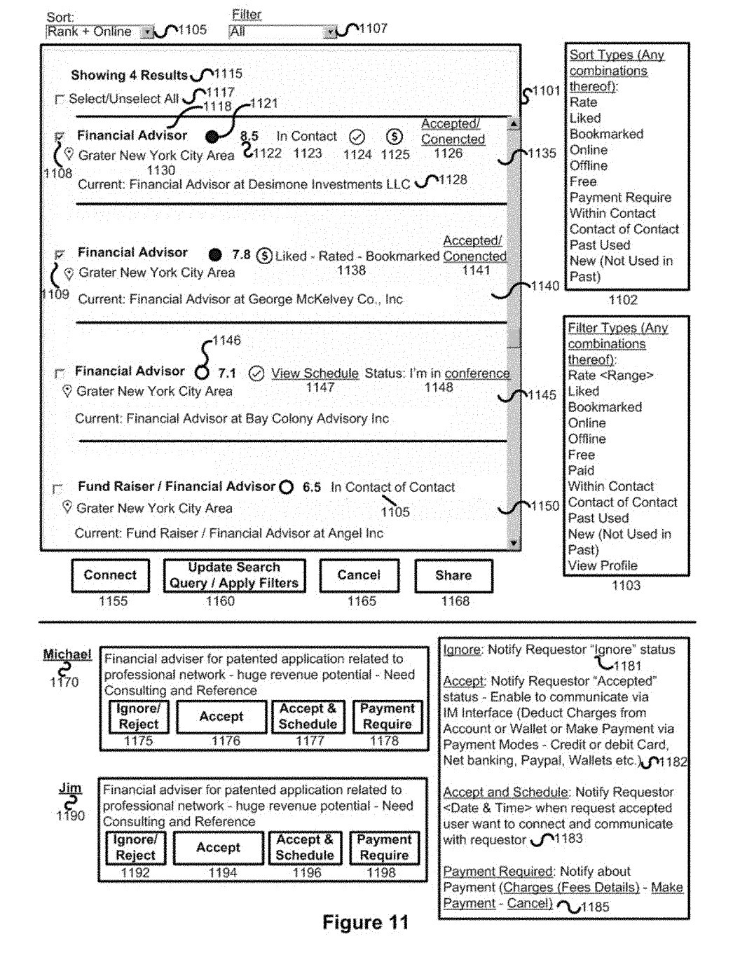

FIGS. 9-10 illustrates example Graphical User interface (GUI) 271 enabling user to prepare search query or request or request to connect with other users of network or search people based on search query or request or requirement specifications, wherein request comprise one or more keywords which entered or inputted by user or select from list or auto-fill keywords or suggested keywords 905, one or more boolean operators AND, OR, and NOT, one or more criteria or filters or operators including Title, Company, First Name, Last Name, School, Skills or Skill Type, one or more Locations, Current Location or Place, within range of location boundaries, type of locations or places, current companies, past companies, industries, profile languages, Years of Experience, Function, Seniority Level, Interested In, Company Size, When Joined, Type of Task, Activity type, Education or qualification, one or more profile fields of user, current status, keywords found in conversation, one or more categories and types, Type of connections including range of rank specific, within contacts, contacts of contacts, liked, bookmarked, any users of network, online, not online or offline, free, paid. User can provide job search filters including date of job posted, salary or salary range, job type including full time, part time, internship, temporary, and contract, locations, company, industry, job function, experience level including internship, entry level, associate, mid-senor level, director, executive. User can provide sort type, number of connection requirements, or search any number of search results, want to search users of network who reply within particular duration (e.g. number of days). User can to provide subject or agenda of connection or brief requirement specification or details 970 to describe purpose, goal, and requirement to connect with searched and selected users of network. User can select one or more templates from list of templates 1015 to show or disclose user's requirement to connect with other users of network. User can select type of task or purpose or activity from list 1005/972. User can select or provide preferences 1005 including type of need, purpose, goal, and requirements, tasks, work to connect with other users of network, wherein type of need, purpose, goal, and requirements comprise want to ask query, need consulting, ask quote, present, market, advertise, compare price, sale or buy products or services, hire or recruit, ask reference and recommendation, apply for job, partnerships, advertisements, invite for event and like. User can select option ask expert 974 to search, match, discover, find out and identify said search query, criteria or filters and settings specific contextual users from network and send to or display to said searching user for review, selection and enable said searching user to select one or more users from said expert provided or human mediated or human identified or human prepared search results and send request to connect to said selected users. User can clear or reset 980 search query or keywords, criteria, filters and settings forms describe in FIG. 9-10 via tapping or clicking on clear or reset button 980. User can cancel search via tapping or clicking on cancel button 985. User can tap on search said user provided search query or keywords, criteria, filters and settings specific users of network via tapping or clicking on search/match button 990. User can click or tap on ask expert button 995 to instruct expert to search, match, discover, find out and identify said search query, criteria or filters and settings specific contextual users from network and receive from said expert search results, so searching user can review and select one or more users from said expert provided or human mediated or human identified or human prepared search results and send request to connect to said selected users or establishing connection with them and then conversation with them or conduct one or more types of communication, collaboration, sharing, participations, activities, actions, transactions, scheduling, participation in event, planning, task or work or project management, assignment, tracking, reviewing or revisions, providing various status, and fulfillment. For example, to search for current Financial Analyst not named James, who have attended either Wharton University or Stanford University, then search query is title: “Financial Analyst” NOT lastname: James school: (Wharton OR Stanford). Searching user can use search operators and use quotes for multi-word search terms, use parentheses for AND, OR and NOT phrases. In the event of click or tap on search/match button 990 by searching user, server module 152 of server 110 receives said request to search users of network from searching user including search query or keywords, one or more types of criteria, boolean operators, filters, conditions, selections, and settings and searches, matches said request specific users of network and retrieves one or more types of information about said searched and matched users of network and based on that generates search results and presents to searching user to user device (discuss in details in FIG. 11). In an embodiment in the event of selection of ask expert 974 option, server module 152 of server 110 forward or notifies or displays said request to one or more selected experts or auto matched experts and receives and aggregates search results from them and send to or displays to searching user to user device (discuss in details in FIG. 11). In an embodiment searching user can select server mediated searching and matching of request specific users of network and/or expert or human mediates searching and matching of request specific users of network and displaying both results together or separately at user interface of user device.

FIG. 11 illustrates example Graphical User interface (GUI) 272 displaying search results 1101 as per search query, filters and settings provided or selected by user, discuss in detail in FIG. 9-10). In the event of click or tap on search/match button 990 by searching user, server module 152 of server 110 receives said request (discuss in FIGS. 9-10) to search users of network from searching user, wherein request comprise search query or keywords, one or more types of criteria, boolean operators, filters, conditions, selections, and settings. Server module 152 searches, matches said request specific users of network and retrieves one or more types of information about said searched and matched users of network and based on that generates search results and presents said search results 1101 (1135/1140/1145/1150) to searching user at Graphical User interface (GUI) and indicates number of search results found and displayed 1115, wherein each search result (For example 1135) does not discloses information about any types of identities and contact information of search result associated user including name and photo of user, email address, phone number, mobile number, fax number, social network identities, any types of contact information, home or work address of user and search result may displays limited profile of user without disclosing any identities and contact information of search result associated user or search result may comprise title, location 1130, current position at particular company 1118, online 1121 or offline 1146 status, ratings 1122, type of user 1123 including in searching user's contact 1123, contacts of contacts 1105, liked or rated or bookmarked 1138 by searching user and nay user of network, if verified user then displays sign or badge or certificate icon 1124, type of payment icon 1125 including free 1139 or fees required to connect with search result item associated user, type of status of connection 1126 including not connected, request send to requestee, request pending or pending to connect, request notified to requestee, request read or viewed by requestee, request accepted by requestee or connected, request ignored or cancelled or rejected by requestee, requestee accepted request and provide schedule of connection, connection paused, connection ended, session ended, mutually connected, liked, blocked, rated, bookmarked, removed or blocked, commented, reported, viewed profile, send number of messages and types of messages, received number of messages and types of messages, task started and in-progress, task paused, task cancelled, task completed. In an embodiment rating of user are based on aggregated average ratings based on ratings provided by users of network, number of bookmarks, likes, comments, number of times accepted requests or connected with requestors, number of times profile viewed, verified user, number of times ignore requests, number of dislikes and reports. Searching user can select or unselect one or more all 1117 search results and can selects one or more search results (For example searching user selects search results 1108 and 1109) and can tap or click on “Connect” button or icon or link or control 1155 to send request to connect to said selected users. In an embodiment user can visit profile of particular user and can tap or click on “Connect” button to send request to connect to said particular user or “Share” button to share profile. Server module 154 receives said request from requestor and then server module 154 prepares and generates notification and send said notification to request associated each requestee or target recipients or said requestor selected each users via one or more communication modes and mediums, channels, device including via push notifications, email, short message service (SMS), voice and inbox of application. Notification comprise subject or brief requirement details or specification or purpose or agenda or need of request to connection with requestee, date & time, ignore button to ignore request, accept button to accept request, accept and schedule button to accept request and schedule request and Payment required button to notify or inform requestor about amount of fees and associated details, rules, policies, package details, payment models and modes. Notification receiving user (For example Michael 1170) can view request associated subject or brief requirement details or specification or purpose or agenda or need of request to connection with requestee and after viewing, reading, analyzing can decide whether the connect or not connect with requestor.

Requestee can tap or click on ignore button to ignore said notification associated request of requestor and in the event of ignore of request by requestee, requestor is notifies about said rejection or ignore or cancellation of request via one or more communication modes and mediums, channels, device including via push notifications, email, short message service (SMS), voice, inbox of application, display notification in prominent place in application like show status in related search result associated with requestee user who ignored request.

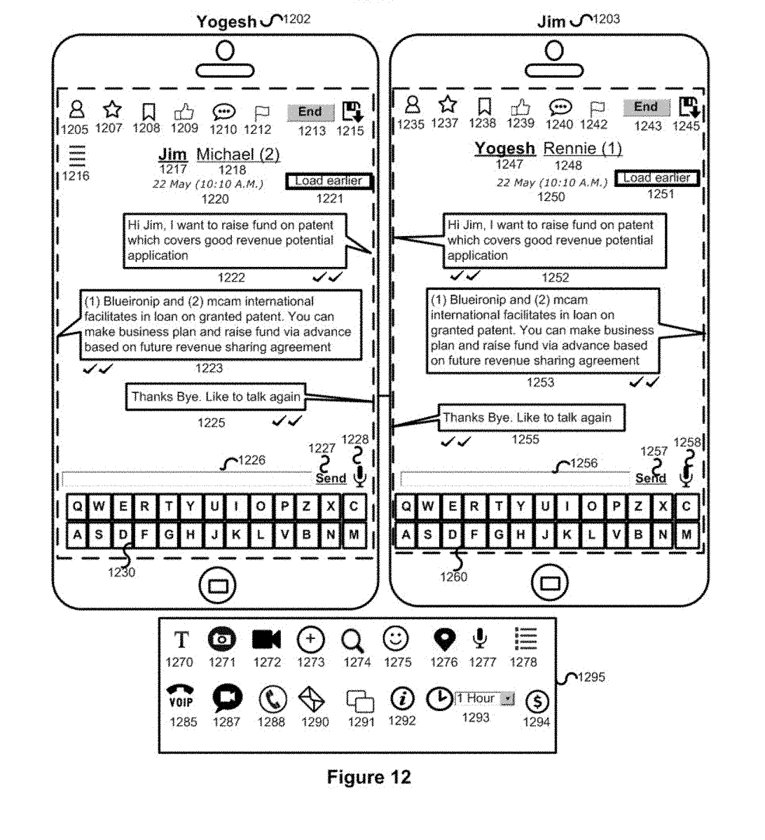

Requestee can tap or click on accept button to accept connection request and in the event of click or tap on accept button by requestee, server module 154 deducts pre-set fees amount from requestor's account for establishing connection between requestor and requestee on the bases of pay per connection model from requestor's account or one or more types of payment wallet or pre-loaded money account, wherein fees decides, updates and set by server administrator. In an embodiment server module 154 instruct or notifies requestor to make payment before connecting requestor with requestee and enable requestor to make said pay per connection payment via one or more types of payment methods including debit or credit card, net banking or any other payment methods. In the event of acceptance of request of requestor by requestee, requestor is notifies about acceptance of request via one or more communication modes and mediums, channels, device including via push notifications, email, short message service (SMS), voice, inbox of application, display notification in prominent place in application like show status 1141 in related search result associated with requestee user who accepted request. After accepting connection request by requestee and making of platform service fees for establishing connection by requestor, server module 154 establishes or starts or initiates communication session and presents one or more types of applications, interfaces, webpages including instant messenger application or enable requestor or requestee user to select one or more types of applications, interfaces, webpages or web based application including instant messenger application and in the event of selection of one or more types of applications, interfaces, webpages, display said selected application or interface or web based application to both requestor and requestee and enable them to communicate, share, collaborate with each other and converse with each other, conduct transaction with each other, do one or more tasks, works and projects and keeps track of said assigned one or more tasks, works and projects (discuss in detail in FIG. 12).

Requestee can tap or click on accept and schedule button to accept connection request and based on schedule of requestee connect with requestor as per schedule and in the event of click or tap on accept and schedule button by requestee, requestee is presented with schedule interface to enable requestee to set date & time to connect with said requestor as per said set date & time. After setting schedule by requestee, server module 154 receives said acceptance and schedule of connection details from requestee and notifies about said schedule to requestor. In an embodiment for establishing connection between requestor and requestee, server module 154 deducts pre-set fees amount from requestor's account or from requestor's one or more type of payment wallet or pre-loaded money account, wherein fees decides, updates and set by server administrator. In an embodiment server module 154 instruct or notifies requestor to make payment before connecting requestor with requestee and enable requestor to make said pay per connection payment via one or more types of payment methods including debit or credit card, net banking or any other payment methods. In the event of acceptance of request of requestor by requestee, requestor is notifies about acceptance of request via one or more communication modes and mediums, channels, device including via push notifications, email, short message service (SMS), voice, inbox of application, display notification in prominent place in application like show status 1141 in related search result associated with requestee user who accepted request. After accepting connection request by requestee and making of platform service fees for establishing connection by requestor and at the time of connection schedule date and time, server module 154 notifies and/or establishes or starts or initiates communication session and presents one or more types of applications, interfaces, webpages including instant messenger application or enable requestor or requestee user to select one or more types of applications, interfaces, webpages or web based application including instant messenger application and in the event of selection of one or more types of applications, interfaces, webpages, display said selected application or interface or web based application to both requestor and requestee and enable them to communicate, share, collaborate with each other and converse with each other, conduct transaction with each other, do one or more tasks, works and projects and keeps track of said assigned one or more tasks, works and projects (discuss in detail in FIG. 12). In an embodiment requestor can accept or reject said schedule or request to changes said schedule as per requestor's one or more schedules and after accepting or rejecting or changes in schedule, server module 154 inform about said accept or reject or change in schedule status to requestee. If changes in schedule then requestee can accept or reject schedule or suggest different schedule, which further notifies to requestor. This process repeats until both accepts schedule or requestee rejects connection request. In an embodiment server module 154 notifies both requestor and requestee before pre-set duration of schedule regarding establishing of connection between requestor and requestee.

In an embodiment if requestee pre-sets or pre-configured fees then requestor needs to make payment to requestee before establishing connection with requestee or server module 154 or system instruct or alert requestor to make payment to send request to connect to said requestor.

In an embodiment if requestee accepts request of requestor and requestee pre-set or pre-configured fees then requestor needs to make payment to requestee before establishing connection with requestee or server module 154 or system instruct or alert requestor to make payment and in the event of making payment to requestee, server module 154 establishes connection between requestor and requestee.

In an embodiment if requestee pre-selected option “Decide fees when receive request” 845 and in the event of requestee taps or clicks on “Payment Require” button associated with received notification of request, requestee is presented with fees interface to prepare custom fees or requestee can use default pre-configured fees information and send to server 110 which receives by server module 154. Server module 154 notifies requestor about said information of fees of requestee and payment require to connect said requestee and displays amount of fees, one or more types of payment models and modes, package details, terms and conditions and rules of requestee to requestor. Requestor is enabled to make said requestee specified payment or fees or charges to said requestee via one or more payment methods or cancel request to connect with said requestee. In an embodiment after acceptance of request by requestee and after establishing connection and communication between requestor and requestee, requestor can make payment as per bills generated by requestee.

In an embodiment after receiving of notification, in the event of non-reply by requestee for pre-set duration, server module 154 removes notification or treat notification as expired and does not enable requestee to take one or more actions on notification or treat one or more actions on notification by requestee as void and notifies requestee about expiration of notification.

In an embodiment searching or viewing user can sort or filter displayed search results, wherein sort types or filter types comprise sort or filter as per Ratings, Rate by user, Liked by user, Bookmarked by user, Commented by user, currently search result item associated user is Online, currently search result item associated user is Offline, search result item associated user is Free or not charging any fees for connection with him, search result item associated user requires payment to establish connection with searching user, search result item associated user is within contact of searching user, search result item associated user is in contacts of contacts, search result item associated user is in past connected with searching user, search result item associated user is not connected in past.

In an embodiment searching user can change or update search query and associate criteria, conditions, filters and settings and in the event of change or update search query and associate criteria, conditions, filters and settings server module 152, displays updated search results at search result interface 1101.

In an embodiment searching user is enabled to cancel search and close search interface.

In an embodiment searching user is enabled to share all or one or more selected search results to one or more requested or selected users by tapping or clicking on “Share” button. So requestor of search result can select one or more search results shared by said searching user or experts and send request to connect to said selected one or more search results associated users.

FIG. 12 illustrates example Graphical User interface (GUI) 273 of one of the example type of application instant messenger application enabling connected users to communicate with each other. In an embodiment connected users (For example Requestor User [Yogesh] 1202 and Requestee User [Jim] 1203) can view and download each other's profile 1205 (show in or discuss in FIG. 5-7) details based on privacy settings wherein profile includes name, photo, contact information like email, phone, home and work address and other all types of details shared by profile owner. In an embodiment connected users can bookmark 1208/1238, provide one or more types of reactions including like 1209/1239, provide ratings 1207/1238, provide one or more reasons of ratings or select one or more template from list of templates to provide one or more reasons for ratings (not shown in figure), provide comments, reviews, feedbacks, complaints 1210/1240 and report including report as fake profile, spam, inappropriate 1212/1242 on each other. In an embodiment connected users can save 1215/1245 conversations locally or at local device storage or at one or more external storage mediums or remote or cloud storage. In an embodiment connected users can end conversation by tapping or clicking on “End” button 1213/1243. In an embodiment connected users can pause or restart paused conversation or restart paused conversation as per schedule decide by both. In an embodiment connected users can send and receive one or more types of contents including text 1270, captured photo 1271, recorded video 1271, selected one or more photos or videos or files 1273, search contents 1274, recorded voice file 1277, lists 1278, one or more types of template contents 1278, emoticons 1275, selected or current location or place information and map and direction information 1276 and can make Voice Over IP (VOIP) call 1285, video call 1287, phone call 1288, send and receive e-mail 1290, Short Message (SMS). In an embodiment user can share profile and one or more types of selective structured and un-structured information 1292. In an embodiment connected users can share screen 1291 and conduct collaboration. In an embodiment connected users can send ephemeral message based on pre-set view duration 1293 and in the event of expiration of pre-set view duration remove said send message from sender's device and/or receiver's device and/or server. In an embodiment connected user can conduct one or more types of transactions, make payment, manage one or more assignments or tasks or works or projects including monitor, track, schedule progress of and status of one or more assignments or tasks or works or projects and associated workflow and activities, actions, events, communications, collaborations and transactions, In an embodiment connected user can connect mutually and participate in one or more types of activities, events, groups, social networks, communications and collaboration. In an embodiment user can make payment 1294 in/from/within application to connected user by using one or more payment methods. In an embodiment in the event of click or tap on button or icon 1216 within application, user is presented with Graphical User Interface (GUI) as described in FIG. 12 to search and connect with other users of network.

In an embodiment requestor user can communicate with one or more requestee (1217/1218) for one or more subjects, tasks, works, projects, queries, requirements by tapping or clicking on auto created switchable tabs (1217/1218) based on establishing of connections between requestor and one or more requestee (1217/1218). For example Requestor user [Yogesh] 1202, can tap or click on tab 1217 to communicate with request accepted or connected or requestee user [Jim] 1203. In an embodiment requestee user can communicate with one or more requestors (1247/1248) for one or more subjects, tasks, works, projects, queries, requirements by tapping or clicking on auto created switchable tabs (1247/1248) based on establishing of connections between requestee and one or more requestors (1247/1248). For example Requestee or request accepted user [Jim] 1203, can tap or click on tab 1247 to communicate with requestor or connected user [Yogesh] 1202. In an embodiment in the event of non-ending of current communication by connected users, auto end communication session after pre-set duration, wherein pre-set duration starts from communication initiation date & time and ends based on expiration of pre-set duration.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

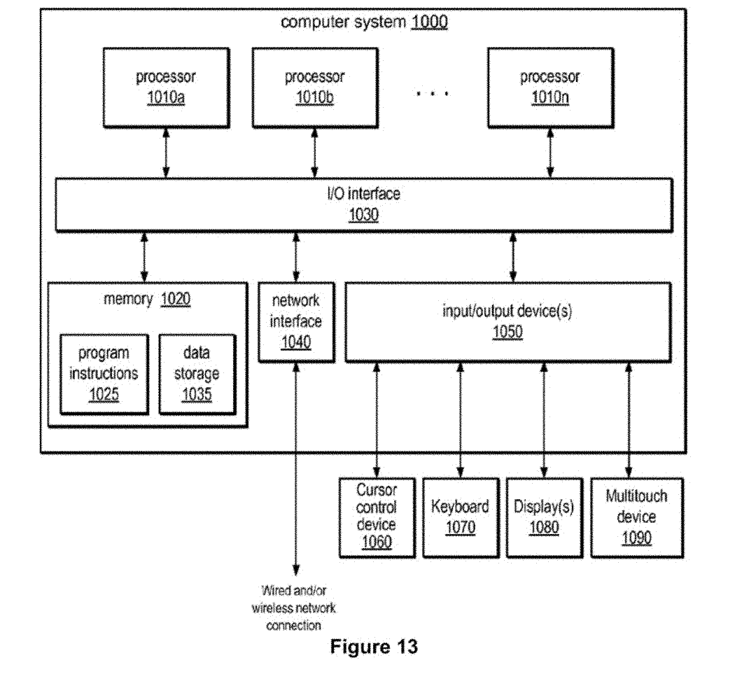

Various components of embodiments of methods as illustrated and described in the accompanying description may be executed on one or more computer systems, which may interact with various other devices. One such computer system is illustrated by FIG. 13. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 13, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claim:

1. A computer-implemented method comprising:
receiving one or more keywords, selections of criteria, filters, operators, brief or agenda or subject, settings and any combination thereof from at least one user of a first plurality of users including from a first computing device of a first user;
determining one or more queries based on at least one of a keywords, selections of criteria, filters, operators, brief or agenda or subject, settings and any combination thereof;
processing data stored in a data store based on at least one query of the one or more queries to identify a second plurality of users;
displaying, to a first computing device of a first user, information about a second plurality of users;
enabling to a first user to select list item(s) from displayed list of a second plurality of users;
enabling to a first user to send request to connect to said each selected list item associated user; and
in the event of acceptance of connection request by said request receiver user or requestee or automatically accept connection request settings provided by requestee, establishing connection or initiating communication session between first user and each request accepted user.

2. The method of claim 1, wherein in the event of ending of communication session by invitor and/or invitee or triggering or applying and executing of one or more pre-defined rules or expiration of pre-set duration timer, end communication session and end connection between invitee and invitor, wherein timer starts from when communication session initiated or established and ends when pre-set duration associated with timer expired.

3. The method of claim 1, wherein notifying invitor about receiving of connection request, wherein notification comprise brief or agenda or subject or type of task provided by invitee, accept option or control to enable invitor to accept connection request, ignore or reject or cancel option or control to enable invitor to ignore or reject or cancel connection request, schedule connection option or control to enable invitor to provide schedule to establish connection between invitor and invitee and payment required to connect option or control to enable invitor to ask invitee to make payment to enable invitor to accept connection request of invitee.

4. The method of claim 1, wherein after acceptance of connection request by invitor and establishment of connection between invitor and invitee, automatically displaying or enabling to select one or more types of one or more interfaces, applications, widgets, webpage, website to both invitor and invitee, wherein interfaces, applications, widgets, webpage, website may comprise instant messenger or chat application, e-mail application, short message service (SMS) application, collaboration application to enable invitee or requestor to communicate or collaborate with one or more request accepted users or connected users, e-commerce or transaction application, social network application, task, workflow and event planning and management application.

5. The method of claim 1, wherein after acceptance of connection request by invitor and establishment of connection between invitor and invitee, charges invitee or with permission invitee based on one or more payment or pricing models including pay per connection model, wherein invitee automatically charge from one or more payment methods including payment wallet or can make payment by using one or more payment methods or instructing invitee to make payment by using one or more payment methods.

6. The method of claim 1, wherein in the event of ignore of connection request by invitor or requestee, notify invitee about ignoring or cancellation or rejection of connection request.

7. The method of claim 1, wherein in the event of scheduling connection establishment by invitor or requestee, establishing connection as per schedule of invitor or notifying invitee about schedule and in the event of acceptance of schedule by invitee, establishing connection as per schedule or in the event of rejection of schedule, cancel request or in the event of providing different schedule by invitee, notifying invitor about said schedule and in the in the event of acceptance of schedule by invitor or requestee, establishing connection as per schedule or in the event of rejection of schedule cancel request.

8. The method of claim 1, wherein in the event of payment require to connect option selected by invitor, notify invitee about charges and enable invitee to view charges provided by inviter and make payment to invitor or requestee or ignore or cancel request to connect and in the event of making payment by invitee, invitor or requestee can accept or accept and schedule connection and in the event of non-acceptance of connection request within pore-set duration reimburse said payment to invitee.

9. The method of claim 1, wherein each list item of list of second plurality of users comprise title, location, current or past companies, position, skills, educations, experiences, online or offline availability or presence information, ratings, type of user including in contact, in contact of contact, liked, rated, bookmarked user by requesting user, verified or certified user, referred user, payment require to connect or free and enabling searching or requesting user or viewing user of search results to sort or filter displayed list of a second plurality of users, wherein sort based on ratings, liked, bookmarked, online available, offline, free, paid users of network, user's contact or contacts of contacts, past connected users, in past not connected users or new users and any combination thereof and filter comprise particular rating of users, liked, bookmarked, online available, offline, free, paid users of network, user's contact or contacts of contacts, past connected users, in past not connected users or new users and any combination thereof.

10. The method of claim 1, wherein search criteria or filter comprise title, one or more current or past companies, schools, colleges, locations including location range, geo-fence boundaries, selected places on map, address, location or place types, type of inductors, profile languages, keywords, one or more types of fields and associate selected or inputted values or data and one or more types of settings comprise search users who are online, offline, free, paid, provide number of connections requirements, type of connections requirements including users who are in requesting or searching user's contacts, contacts or contacts, liked, bookmarked, rated users, ranked users of network or any users of network.

11. A system comprising: a computing device; and a computer-readable medium coupled to the computing device and having instructions stored thereon which, when executed by the computing device, cause the computing device to perform operations comprising:
receive one or more keywords, selections of criteria, filters, operators, brief or agenda or subject, settings and any combination thereof from at least one user of a first plurality of users including from a first computing device of a first user;
determine one or more queries based on at least one of a keywords, selections of criteria, filters, operators, brief or agenda or subject, settings and any combination thereof;
process data stored in a data store based on at least one query of the one or more queries to identify a second plurality of users;
display, to a first computing device of a first user, information about a second plurality of users;
enable to a first user to select list item(s) from displayed list of a second plurality of users;
enable to a first user to send request to connect to said each selected list item associated user; and
in the event of acceptance of connection request by said request receiver user or requestee or automatically accept connection request settings provided by requestee, establish connection or initiate communication session between first user and each request accepted user.

12. The system of claim 11, wherein in the event of ending of communication session by invitor and/or invitee or triggering or applying and executing of one or more pre-defined rules or expiration of pre-set duration timer, end communication session and end connection between invitee and invitor, wherein timer starts from when communication session initiated or established and ends when pre-set duration associated with timer expired.

13. The system of claim 11, wherein notify invitor about receiving of connection request, wherein notification comprise brief or agenda or subject or type of task provided by invitee, accept option or control to enable invitor to accept connection request, ignore or reject or cancel option or control to enable invitor to ignore or reject or cancel connection request, schedule option or control connection to enable invitor to provide schedule to establish connection between invitor and invitee and payment required to connect option or control to enable invitor to ask invitee to make payment to enable invitor to accept connection request of invitee.

14. The system of claim 11, wherein after acceptance of connection request by invitor and establishment of connection between invitor and invitee, automatically display or enable to select one or more types of one or more interfaces, applications, widgets, webpage, website to both invitor and invitee, wherein interfaces, applications, widgets, webpage, website may comprise instant messenger or chat application, e-mail application, short message service (SMS) application, collaboration application to enable invitee or requestor to communicate or collaborate with one or more request accepted users or connected users, e-commerce or transaction application, social network application, task, workflow and event planning and management application.

15. The system of claim 11, wherein after acceptance of connection request by invitor and establishment of connection between invitor and invitee, charges invitee or with permission invitee based on one or more payment or pricing models including pay per connection model, wherein invitee automatically charge from one or more payment methods including payment wallet or can make payment by using one or more payment methods or instructing invitee to make payment by using one or more payment methods.

16. The system of claim 11, wherein in the event of ignore of connection request by invitor or requestee, notify invitee about ignoring or cancellation or rejection of connection request.

17. The system of claim 11, wherein in the event of scheduling connection establishment by invitor or requestee, establishing connection as per schedule of invitor or notifying invitee about schedule and in the event of acceptance of schedule by invitee, establishing connection as per schedule or in the event of rejection of schedule, cancel request or in the event of providing different schedule by invitee, notifying invitor about said schedule and in the in the event of acceptance of schedule by invitor or requestee, establishing connection as per schedule or in the event of rejection of schedule cancel request.

18. The system of claim 11, wherein in the event of payment require to connect option selected by invitor, notify invitee about charges and enable invitee to view charges provided by inviter and make payment to invitor or requestee or ignore or cancel request to connect and in the event of making payment by invitee, invitor or requestee can accept or accept and schedule connection and in the event of non-acceptance of connection request within pore-set duration reimburse said payment to invitee.

19. The system of claim 11, wherein each list item of list of second plurality of users comprise title, location, current or past companies, position, skills, educations, experiences, online or offline availability or presence information, ratings, type of user including in contact, in contact of contact, liked, rated, bookmarked user by requesting user, verified or certified user, referred user, payment require to connect or free and enable searching or requesting user or viewing user of search results to sort or filter displayed list of a second plurality of users, wherein sort based on ratings, liked, bookmarked, online available, offline, free, paid users of network, user's contact or contacts of contacts, past connected users, in past not connected users or new users and any combination thereof and filter comprise particular rating of users, liked, bookmarked, online available, offline, free, paid users of network, user's contact or contacts of contacts, past connected users, in past not connected users or new users and any combination thereof.

20. The system of claim 11, wherein search criteria or filter comprise title, one or more current or past companies, schools, colleges, locations including location range, geo-fence boundaries, selected places on map, address, location or place types, type of inductors, profile languages, keywords, one or more types of fields and associate selected or inputted values or data and one or more types of settings comprise search users who are online, offline, free, paid, provide number of connections requirements, type of connections requirements including users who are in requesting or searching user's contacts, contacts or contacts, liked, bookmarked, rated users, ranked users of network or any users of network.
